(19) United States
(12) Patent Application Publication
(10) Pub. No.: US 2025/0297677 A1
(43) Pub. Date: Sep. 25, 2025

(54) SHIFTING ARRANGEMENT OF A GEARSET OF A VEHICLE

(71) Applicant: ZF Friedrichshafen AG, Friedrichshafen (DE)

(72) Inventors: David Rittler, Neukirch (DE); Andreas Acker, Meckenbeuren (DE); Michael Trübenbach, Friedrichshafen (DE); Stefan Spühler, Friedrichshafen (DE)

(73) Assignee: ZF Friedrichshafen AG, Friedrichshafen (DE)

(21) Appl. No.: 19/087,736

(22) Filed: Mar. 24, 2025

(30) Foreign Application Priority Data
Mar. 25, 2024 (DE) 10 2024 202 833.9

(51) Int. Cl. F16H 61/28

(52) U.S. Cl. CPC F16H 61/28

(57) ABSTRACT

A shifting mechanism of a transmission gearset of a vehicle has an axially displaceable sliding sleeve for transmitting torque between shift partners to produce various gear-step transmission ratios. The sliding sleeve and the shift partners are in the form of gear-step gearwheels arranged coaxially with a rotation axis. The sliding sleeve has a first toothed section and a second toothed section for the transmission of torque between the shift partners. At least one of the shift partners has a sliding gear section that can be brought into engagement with one of the toothed sections of the sliding sleeve. At least the first and second toothed sections of the sliding sleeve are each in the form of gearshift teeth. A transmission gearset is provided with a shifting mechanism of this type.

### RELATED APPLICATIONS

This application claims the benefit of and right of priority under 35 U.S.C. § 119 to German Patent Application no. 10 2024 202 833.9, filed on 25 Mar. 2024, the contents of which are incorporated herein by reference in its entirety.

### FIELD OF THE DISCLOSURE

The present invention relates to a shifting arrangement or mechanism of a transmission gearset of a vehicle with an axially displaceable sliding sleeve for transmitting torque between shift partners in order to produce gear-step transmission ratios. In addition, the invention relates to a transmission gearset with such a shifting mechanism.

### BACKGROUND

Shifting arrangements for a transmission gearset of a vehicle are known from automotive technology. Every shifting arrangement comprises an axially displaceable sliding sleeve for producing a connection for the purpose of transmitting torque between the shift partners in order to engage various gear-step transmission ratios. For that purpose, the sliding sleeve comprises a first toothed section as a sliding gear and a second toothed section as gearshift teeth. The sliding gear of the sliding sleeve can move axially within a sliding gear section of a first shift partner between different shift positions, but the sliding gear of the sliding sleeve always remains engaged with the sliding gear section of the shift partner. Depending on the shift position reached in the sliding gear section, the second toothed section of the sliding sleeve engages either with gearshift teeth of one shift partner in order to obtain a first gear-step transmission ratio, or with gearshift teeth of another shift partner in order to obtain a second gear-step transmission ratio.

In order to maintain the shift position, the sliding gear of the sliding sleeve and the corresponding sliding gear section of the associated shift partner have a lodgment which forms a recess in the tooth geometry on the flank of the teeth, whereby the tooth gap between the teeth of the sliding gear is increased. Due to the torque applied the tooth of the shift partner comes into contact with the recessed tooth flank, whereby resulting forces act which hold the sliding sleeve in the shift position concerned.

### SUMMARY

The purpose of the present invention is to propose a shifting arrangement and a transmission gearset with a shifting arrangement by virtue of which a sliding gear provided can also be used as gearshift teeth.

According to the invention, this objective is achieved by the features of a shifting mechanism as variously disclosed herein. Advantageous and claimed further developments emerge from the present disclosure, including the description and the drawings.

Accordingly, a shifting arrangement of a transmission gearset of a vehicle is proposed, with an axially displaceable sliding sleeve for transmitting torque between shift partners in order to engage various gear-step transmission ratios, wherein the sliding sleeve and the shift partners in the form of gear-step gearwheels are arranged coaxially with a rotation axis, wherein the sliding sleeve has a first toothed section and a second toothed section for torque transmission between the shift partners, wherein at least one shift partner has a sliding gear section which can be brought into engagement with one of the toothed sections of the sliding sleeve, and wherein at least the first toothed section and the second toothed section of the sliding sleeve are each in the form of gearshift teeth.

In this way, and by virtue of the proposed shifting arrangement, the functions of a sliding gear and the functions of gearshift teeth are combined with one another, so that depending on the gear situation the shifting arrangement can be used as a sliding gear or as pure gearshift teeth. In that way, the proposed shifting arrangement provides both the advantages of a sliding gear such as securing or holding the shift position, and also the advantages of gearshift teeth, such as better single-lane behavior. Furthermore, there is the advantage that the proposed shifting arrangement can be used to good effect even when there are fitting space restrictions.

To be able to also use the sliding gear as gearshift teeth, it is provided that the teeth of the toothed sections of the sliding sleeve each have on the axial side at least one switching edge extending obliquely at a predetermined angle relative to the rotation axis of the sliding sleeve, or the like. Thanks to the angled switching edge, the single-lane behavior is much improved. If the shift partner also has the oblique switching edge on the teeth, this results in better centering of the sliding sleeve, particularly when it is only mounted locally.

The angle of the obliquely extending switching edge between the rotation axis and the course of the switching edge is preferably an acute angle. The range of the predetermined angle value is larger than 0° and smaller than 90° a value in the middle of the two limit values indicated being preferred.

So that the geometries at the various teeth can get clear of one another, it is provided that the sliding gear section on one of the shift partners of the sliding sleeve has at least a first shift position and a second shift position for the associated toothed section of the sliding sleeve, so that at least at or in the area of the shift positions in each case at least one switching edge or similar extending obliquely at a predetermined angle relative to the rotation axis is provided. The size of the predetermined angle is in a value range between larger than 0° and smaller than 90°.

With the shifting arrangement proposed, it is possible for the sliding sleeve, with its first toothed section, to engage with the first shift position or with the second shift position of the sliding gear section of the shift partner and for the sliding sleeve with its second toothed section to engage with a shifting gear of another shift partner. In that case the first toothed section is used as if in the manner of a sliding gear and the second toothed section of the sliding sleeve as gearshift teeth.

It is also conceivable that the sliding sleeve with its first toothed section engages with gearshift teeth of a shift partner, and that the sliding sleeve with its second toothed section engages with gearshift teeth of a further shift partner. In that case both toothed sections of the sliding sleeve are used as gearshift teeth.

The stated objective of the invention is also achieved with a transmission gearset having a shifting arrangement as described earlier, with which the advantages already described and other advantages are obtained.

### BRIEF DESCRIPTION OF THE DRAWINGS

Below, the present invention is explained in greater detail with reference to the drawings.

The drawings show:

FIG. 1: A schematic sectioned view of an embodiment variant of a shifting arrangement according to the invention, with a first toothed section of a sliding sleeve engaged in a first shift position of a sliding gear section of a first shift partner, and with a second toothed section of the sliding sleeve engaged in gearshift teeth of a second shift partner in order to produce a first gear-step transmission ratio in a transmission gearset of a vehicle;

FIG. 2: A schematic sectioned view of the shifting arrangement with the first toothed section of the sliding sleeve engaged in a second shift position of the first shift partner, and with the second toothed section of the sliding sleeve engaged in gearshift teeth of a third shift partner in order to produce a second gear-step transmission ratio; and

FIG. 3: A schematic sectioned view of the shifting arrangement with the first toothed section of the sliding sleeve engaged in gearshift teeth of a fourth shift partner, and with the second toothed section of the sliding sleeve engaged in gearshift teeth of a fifth shift partner, in order to produce a third gear-step transmission ratio.

### DETAILED DESCRIPTION

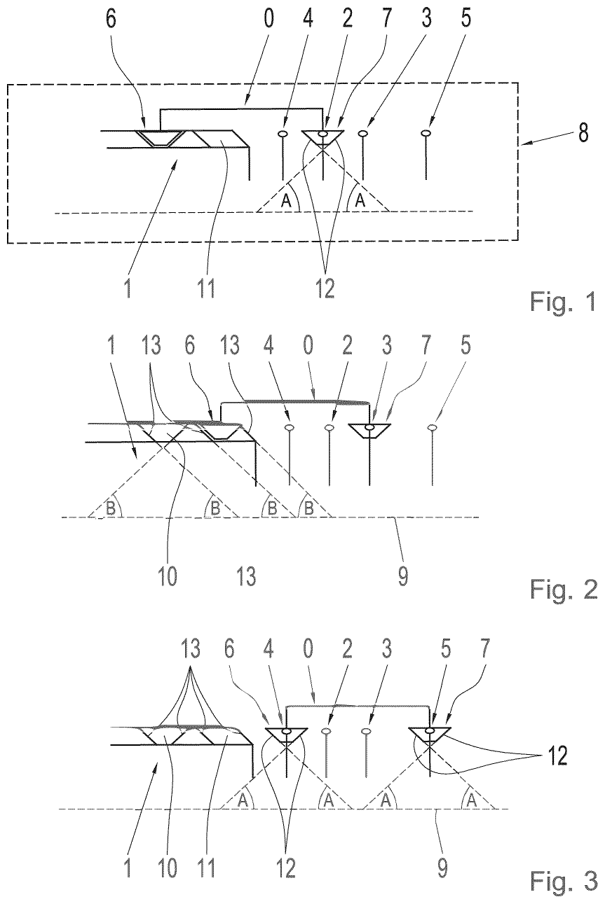

In FIGS. 1 to 3 various schematic sectioned views are shown, in the peripheral direction as if through the toothed section concerned of a sliding sleeve 0 and associated shift partners 1, 2, 3, 4, and 5 of a shifting arrangement, according to the invention in a transmission gearset 8 of a vehicle.

The sliding sleeve 0 can be moved axially and is provided with internal teeth which form a first toothed section 6 and a second toothed section 7. For torque transmission between the shift partners 1, 2, 3, 4, 5 the sliding sleeve 0 is moved axially so that in the embodiment variant shown, for example, three different gear-step transmission ratios can be produced with the five shift partners 1, 2, 3, 4, 5. Both the sliding sleeve 0 and also the shift partners 1, 2, 3, 4, 5 in the form of gear-step gearwheels are arranged coaxially with one another on a common rotation axis.

In the embodiment variant of the shifting arrangement shown, a first shift partner 1 of the shifting arrangement has a sliding gear section with a first shift position 10 and a second shift position 11 for the first toothed section 6 of the sliding sleeve 0. The shift positions 10 and 11 have a lodgment for the holding or retention of the sliding sleeve 0 in the position 10 or 11 concerned.

In order to provide both a sliding gear and also gearshift teeth on the sliding sleeve 0 in the shifting arrangement proposed, it is provided that at least the first toothed section 6 and the second toothed section 7 of the sliding sleeve 0 are each in the form of gearshift teeth.

For that purpose, the gearshift teeth of the toothed sections 6 and 7 of the sliding sleeve 0 are provided with a switching edge 12 that extends obliquely at a predetermined angle A relative to the rotation axis 9 of the sliding sleeve 0. The predetermined angle A is an acute angle, and in the embodiment shown, is of a size in a middling range between larger than 0° and smaller than 90°, namely, around 45° as shown in particular in FIG. 1.

As can be seen in FIGS. 1 to 3, the toothed sections 6 and 7 of the sliding sleeve 0 are each in the form of internal teeth, such that in each case on the teeth of the internal toothed section the switching edge 12 arranged on the axial side, starting from a tooth root to the tooth crown, extends at the predetermined angle A in such manner that the switching edges on the two axial sides of each tooth of the gearshift teeth face toward one another in cross-section or in the sectioned view in the peripheral direction, as shown in FIGS. 1 to 3.

In the area of the lodgment or in the shift positions the sliding gear section on the first shift partner 1 of the sliding sleeve 0 has a plurality of shifting edges 13 extending obliquely at a predetermined angle B relative to the rotation axis 9. The size of the predetermined angle B is in the same range of values as the predetermined angle A.

In FIG. 1 a condition of the shifting arrangement is shown in which a first gear-step transmission ratio is produced by the sliding sleeve 0, in which the sliding sleeve 0 connects the first shift partner 1 to the second shift partner 2. In this case the first toothed section 6 of the sliding sleeve 0 is engaged with the sliding gear section at the first shift position 10, whereas the second toothed section 7 of the sliding sleeve 0 is engaged with the gearshift teeth of the second shift position 2.

To move the sliding sleeve 0 axially out of that condition and into the second shift position 11 of the sliding gear section of the first shift partner 1, in the area of the shift positions 10 and 11 the siding gear section also has the obliquely extending shifting edges 13.

FIG. 2 shows a condition of the shifting arrangement in which a second gear-step transmission ratio is produced by the sliding sleeve 0, in which the sliding sleeve 0 connects the first shift partner 1 to a third shift partner 3 for torque transmission. In this case the first toothed section 6 of the sliding sleeve 0 with the sliding gear section engages in the second shift position 11, while the second toothed section 7 of the sliding sleeve 0 engages with the gearshift teeth of the third shift partner 3.

FIG. 3 shows a condition of the shifting arrangement by means of which a third gear-step transmission ratio is produced by the sliding sleeve 0, in which the sliding sleeve 0 connects a fourth shift partner 4 with a fifth shift partner 5. For that purpose, it is necessary for the sliding sleeve 0 to disengage from the sliding gear section of the first shift partner 1 in order, independently of the first shift partner 1, to produce the third gear-step transmission ratio with the fourth shift partner 4 and the fifth shift partner 5.

In order to be able to shift out of the third gear-step transmission ratio again into the first gear-step transmission ratio or the second gear-step transmission ratio, it is necessary for the sliding sleeve 0 to move back again to the sliding gear section of the first shift partner 1. For this engagement and disengagement, at the beginning of the sliding gear section, in the second shift position on the first shift partner 1, the obliquely extending shifting edge 13 is also provided, just as in the other areas of the shift positions 10 and 11, preferably in the area of the lodgment.

### INDEXES

0 Sliding sleeve
1 First shift partner
2 Second shift partner
3 Third shift partner
4 Fourth shift partner
5 Fifth shift partner
6 First toothed section of the sliding sleeve
7 Second toothed section of the sliding sleeve
8 Transmission gearset
9 Rotation axis
10 First shift position on the first shift partner
11 Second shift position on the first shift partner
12 Switching edge of the toothed section in the sliding sleeve
13 Switching edge of the first shift partner
A Predetermined angle of the switching edge on the sliding sleeve
B Predetermined angle on the first shift partner

1. A shifting mechanism of a transmission gearset (8) of a vehicle, comprising:
an axially displaceable sliding sleeve (0) configured and arranged for transmitting torque between shift partners (1, 2, 3, 4, 5) in order to produce various gear-step transmission ratios;
wherein the sliding sleeve (0) and the shift partners (1, 2, 3, 4, 5) are in the form of gear-step gearwheels arranged coaxially with a rotation axis (9);
wherein the sliding sleeve (0) has a first toothed section (6) and a second toothed section (7) for the transmission of torque between the shift partners (1, 2, 3, 4, 5);
wherein at least one of the shift partners (1) has a sliding gear section configured to be brought into engagement with one of the toothed sections (6, 7) of the sliding sleeve (0); and
wherein at least the first toothed section (6) and the second toothed section (7) of the sliding sleeve (0) are in the form of gearshift teeth.

2. The shifting mechanism according to claim 1, wherein the gearshift teeth of the toothed sections (6, 7) of the sliding sleeve (0) have a switching edge (12) that extends obliquely at a predetermined angle (A) relative to the rotation axis (9) of the sliding sleeve (0).

3. The shifting mechanism according to claim 2, wherein the predetermined angle is an acute angle.

4. The shifting mechanism according to claim 2, wherein the size of the predetermined angle (A) is in a value range larger than 0° and smaller than 90°.

5. The shifting mechanism according to claim 4, wherein the sliding sleeve (0) has respective internal teeth for its toothed sections (6, 7), wherein on each tooth of the internal teeth a switching edge (12) extends on the axial side at the predetermined angle (A) starting from a tooth root to the tooth crown, in such manner that the switching edges on the two axial sides of each tooth face toward one another in cross-section.

6. The shifting mechanism according to claim 2, wherein the sliding gear section on one of the shift partners (1) has at least a first shift position (10) and a second shift position (11) for the associated toothed section of the sliding sleeve (0), wherein at least in an area of each of the first and second shift positions (10, 11) the gearshift teeth have at least one switching edge (13) extending at a predetermined angle (B) relative to the rotation axis (9).

7. The shifting mechanism according to claim 6, the predetermined angle (B) is larger than 0° and smaller than 90°.

8. The shifting mechanism according to claim 7, wherein the sliding sleeve (0), with the first toothed section (10), engages with the first shift position (10) or with the second shift position (11) of the sliding gear section of the shift partner (1), and the sliding sleeve (0), with the second toothed section (7), engages with gearshift teeth of a further shift partner (2, 3, 4, 5).

9. The shifting mechanism according to claim 1, wherein with the first toothed section (6) the sliding sleeve (0) engages with gearshift teeth of a shift partner (2, 3, 4, 5), and with the second toothed section (7) the sliding sleeve (0) engages with gearshift teeth of a further shift partner (2, 3, 4, 5).

10. A transmission gearset (8) having the shifting mechanism according to claim 1.
